(19) United States
(12) Patent Application Publication
(10) Pub. No.: US 2023/0220514 A1
(43) Pub. Date: Jul. 13, 2023

(54) SYSTEMS AND METHODS FOR HYDROMETALLURGICAL, ANTI-SOLVENT, AND ELECTROCHEMICAL RECOVERY OF METALS FROM WASTES AND ASHES

(71) Applicant: The Trustees of Columbia University in the City of New York, New York, NY (US)

(72) Inventors: Ah-Hyung Alissa PARK, New York, NY (US); Peng PENG, Emeryville, CA (US); Haonan Danny HUANG, Glendora, CA (US)

(21) Appl. No.: 18/094,588

(22) Filed: Jan. 9, 2023

Related U.S. Application Data
(60) Provisional application No. 63/437,792, filed on Jan. 9, 2023.
(60) Provisional application No. 63/297,324, filed on Jan. 7, 2022.

(51) Int. Cl. C22B 3/04; C01F 1/00; C22B 4/04; C22B 3/16

(52) U.S. Cl. CPC C22B 3/045; C01F 1/00; C22B 4/04; C22B 3/16

(57) ABSTRACT

A plurality of different metals, including precious metals, platinum group metals, rare earth elements, alkaline earth metals, etc., can be electrochemically recovered from waste materials such as ashes and e-waste, e.g., printed circuit boards. Waste feed stocks are treated with supercritical CO₂ (scCO₂) and acid to produce a solid delaminated waste and a liquid delaminated waste for recovery of elemental metals and metal compounds from each. Carbonation reactions can be used to convert and recover alkaline earth metals from the liquid delaminated waste. The solid delaminated waste can yield a solid gold product, and be further treated along with the liquid delaminated waste via a solvent including one or more organic ligands that bind target metals to form metal-ligand complexes. Electrochemical separation of the different metals, e.g., via stepwise variation of pH to release the metals from organic ligands having different pKa values, yields high purity metal product streams.

### CROSS REFERENCE TO RELATED APPLICATION(S)

This application claims the benefit of U.S. Provisional Application Nos. 63/297,324, filed Jan. 7, 2022, and 63/437,792, filed Jan. 9, 2023, which are incorporated by reference as if disclosed herein in their entireties.

### STATEMENT REGARDING FEDERALLY SPONSORED RESEARCH OR DEVELOPMENT

This invention was made with government support under Grant Number GG008677 awarded by National Science Foundation. The government has certain rights in the invention.

### BACKGROUND

Electronic waste (e-waste) is one of the fastest growing waste segments in the world. The management of waste, particularly e-waste, has become a significant challenge faced by humanity as the globe becomes increasingly connected and automated. Worldwide, the number of discarded computers, phones, and other appliances reached 45 million tons in 2016, and based upon projections, this number could exceed 50 million tons by 2021. Presently, the disposal of e-waste encompasses recycling the nontoxic, valuable components and releasing the toxic components into the surroundings, most often via pyrometallurgy (incineration and smelting). Despite increasing efforts to improve its recycling and reuse, a large fraction of e-waste is still being disposed in the environment. Furthermore, the amount of e-waste being transferred/exchanged between states and countries (particularly to developing countries) is causing significant social and economic complications. The exposed metals, plastics, and brominated organic flame retardants have led to various environmental and public health concerns around the globe; consequently, much research has been dedicated to developing new recycling methods for e-waste with an emphasis on green metal extraction and recovery. The recovery of metals from e-waste could provide a sustainable pathway to reduce the conventional mining and the landfilling of electronic waste while bringing significant economic benefits due to the value of the recovered materials.

E-waste is an intricate mixture of metals, plastics, and refractory material. The amount of valuable metals in e-waste depends on the type of waste. Printed circuit boards (PCBs), a major constituent of e-waste, contain one of the highest concentrations of base and precious metals. The overall composition of PCBs is approximately 40% metals, 30% organics, and 30% refractory. Copper is the most abundant metal in PCB, comprising 20% of the metal content, and its recovery has high economic value. Other base metals found in PCB include Fe, Al, and Ni, in addition to precious metals, e.g., Au and Ag. The organic content of PCB includes various polymers, such as polycarbonate (PC) and polyvinyl chloride (PVC), and the refractory materials are silica and alkaline oxides. Brominated flame retardants (BFRs) are included in polymers in PCBs and are of particular concern due to their toxicity. BFRs such as poly-brominated diphenyl ether (PBDE) and tetrabromo-bisphenol A (TBBA) can react with oxygen to form dioxins. Spiked brominated organics, e.g., diphenyl ethers, have been observed in the environment and in animal bodies, thus increasing the risk of food chain contamination and species endangerment. Furthermore, elevated health risks have been associated with the growth and improper disposal of e-waste, such as high lead content in the blood of children in developing countries.

Conventional treatment of PCB generally includes physical processing and separation followed by metal extraction and recovery. The crushing of PCB to fine particle sizes along with other mechanical methods tends to be energy and labor-intensive. Shredding and grinding processes can also produce dangerous dusts and dioxins, and metal losses of up to 40% have been reported during mechanical processing. Thermal and chemical treatments, such as pyrolysis and supercritical fluids, are also utilized, particularly to remove the flame-retarding polymeric components and recover the plastics. These processing steps play a critical role in metal separation and recovery, affecting the ultimate amount of metal recovered and the overall efficiency of metal recycling. Two main routes are used for the separation and recovery of metals, namely pyrometallurgy and hydrometallurgy.

Pyrometallurgy, that is incineration and smelting, is the most standard treatment method. Approximately 70% of waste PCBs are treated in smelters, instead of undergoing mechanical processing. Pyrometallurgy has proven effective and economically viable, but the risks of toxic gas release and dioxin formation combined with the formation of slag waste are limitations. Most pyrometallurgical processes only yield high Cu recovery, losing Al and Fe to the slag. Emission control systems, such as the one installed at the advanced smelter, Umicore plant in Belgium, are costly.

Hydrometallurgy is an alternative method involving chemical leaching with acids, such as nitric acid and sulfuric acid, followed by metal recovery from the leached solutions via techniques such as cementation and solvent extraction. A recent development in hydrometallurgy is bioleaching, which uses acidophilic groups of bacteria to leach metals from PCB. In recent years, hydrometallurgy has become the more prominent method for the benefits it affords, compared to pyrometallurgy. Hydrometallurgical techniques are more controllable, environmentally-friendly, and precise. There are four conventional techniques, including acid leaching, cyanide leaching, thiosulfate leaching, and thiourea leaching.

Acid leaching, the most popular route, results in high leaching rates and allows for metal-specific leaching, but is corrosive, especially when used in large amounts. Some examples of acid systems include nitric acid, which is commonly used to leach Cu but cannot be used directly for electroplating, and sulfuric acid and hydrogen peroxide, which is highly effective for leaching of Cu but can be corrosive at high concentrations. Aqua regia, the most effective solvent for leaching of metals, yields the highest Cu extraction; yet, it is the most corrosive leaching agent and presents hazards when used in large amounts.

Cyanide leaching was traditionally used for gold mining, but has begun to be disregarded due to its toxicity. Thiosulfate and thiourea leaching, on the other hand, are greener processes used for precious metal extraction, particularly in the leaching of Au and Ag. Ammoniacal thiosulfate solutions have been demonstrated to yield 95% Au and 100% Ag extracted from PCBs of mobile phones. However, this reaction is time-consuming, lasting from 24 to 48 hours in total. Additionally, the presence of Cu and Al can cause low Au extraction efficiencies in thiosulfate solutions because of the re-deposition of extracted Au ions. Researchers have investigated different combinations of physical pre-treatment schemes to overcome these challenges regarding Au extraction in ammonium thiosulfate media. Thiourea leaching with ferric ion as an oxidant has been shown to yield 86% Au and 71% Ag extraction, but is quite costly and requires a large amount of solvent for a small amount of solid. There are drawbacks associated with each of the different leaching chemistries, and thus, research efforts in hydrometallurgy, particularly metal extraction, have focused on reducing the amount of corrosive acids used and developing greener solvent systems for chemical leaching.

Supercritical fluids present an interesting, greener alternative to acid leaching, and have been increasingly studied by researchers. Processes with supercritical H₂O have been shown to be effective for the removal of BFRs. Researchers have shown that treatment with supercritical water results in 97.6% debromination efficiency. Supercritical water has even been combined with acid leaching for metal extraction from PCBs. Two pre-treatment processes, supercritical water oxidation (SCWO) and supercritical water depolymerization (SCWD), together with HCl leaching, proved effective for the recovery of Cu, reaching 99.8% Cu recovery.

Other solvents, beyond supercritical water, have also been utilized for the debromination of waste PCBs. Recently, a low temperature near critical aqueous ammonia (NCAA) process was demonstrated to yield 100% Br removal at 300° C. with a reaction time of 60 minutes. The NCAA treatment was tested at varying temperatures of 200-350° C., reaction times of 30-90 minutes, and ammonia concentrations of 1.7-7.4 M. High debromination efficiencies were only achieved at high concentrations of ammonia, specifically 4.1 mol/L and 7.4 mol/L.

Subcritical methanol (subCM) was explored for the removal of PBDE from waste PCBs. In this process with subCM, the minimum reaction temperature was 200° C. and minimum reaction time was 60 minutes. For the complete removal of PBDE, a temperature of 300° C. was deemed necessary when using subCM alone, and a slightly lower temperature of 250° C. was required when using subCM with NaOH. The main disadvantage of supercritical water, NCAA, and subCM treatments is the high temperature requirement. Supercritical water processes require temperatures of 420-440° C., while NCAA and subCM processes require temperatures greater than 200° C.

### SUMMARY

Aspects of the present disclosure are directed to a method of recovering metals from waste materials. In some embodiments, the method includes treating a waste feed stock with supercritical CO₂ (scCO₂) and at least one acid to produce a solid delaminated waste and a liquid delaminated waste; separating the solid delaminated waste into an enriched-metal solid delaminated waste and an enriched-polymer solid delaminated waste; treating the enriched-metal solid delaminated waste, liquid delaminated waste, or combinations thereof, with a solvent including one or more organic ligands to form a solution, the organic ligands configured to bind at least one target metal in the enriched-metal solid delaminated waste to form at least a first-metal-ligand complex; and electrochemically separating a first product from the solution, the first product including a first metal from the first-metal-ligand complex. In some embodiments, the method includes electrochemically separating at least a second product from the solution, the second product including a second metal from the second-metal-ligand complex. In some embodiments, the method includes electrochemically separating at least a second product from the solution includes altering the pH of the solution to release the second metal from the second-metal-ligand complex.

In some embodiments, separating the solid delaminated waste into an enriched-metal solid delaminated waste and an enriched-polymer solid delaminated waste includes a flotation separation process, gravity separation process, or combinations thereof. In some embodiments, the method includes isolating a product including solid gold from the solid delaminated waste prior to treatment with the solvent. In some embodiments, isolating a product including solid gold from the solid delaminated waste prior to treatment with the solvent includes contacting the solid delaminated waste with an internal grinding medium. In some embodiments, the method includes carbonating alkaline earth metals from the liquid delaminated waste to form an alkaline earth metal product; and isolating an alkaline earth metal product including carbonated alkaline earth metals. In some embodiments, the method includes contacting at least a portion of the solution with scCO₂; and precipitating a rare-earth-element (REE) product including REE-ligand complexes from the solution.

In some embodiments, the first metal and the second metal are different. In some embodiments, the liquid delaminated waste includes alkaline earth metals, transition metals, and/or rare earth elements (REEs), e.g., copper, cobalt, nickel, aluminum, calcium, magnesium, barium, strontium, manganese, vanadium, titanium, iron, zinc, neodymium, praseodymium, dysprosium, or combinations thereof. In some embodiments, the organic ligands include an acetic acid, a propionic acid, a valeric acid, a butyric acid, a carboxylic acid, a phosphoric acid, a primary amine compound, a quaternary amine compound, hydroxyoximes, organophosphorus acids, dialkylsulphoxides, diglycoamides, thiodiglycoamides, malonamides, diisopentylsulfides, pyridine-carboxamides, dialkyl/arylureas, or combinations thereof. In some embodiments, the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof. In some embodiments, the waste feed stock includes fly ash, iron slag, steel slag, red mud, printed circuit board, or combinations thereof.

Aspects of the present disclosure are directed to a system for recovering metals from waste materials. In some embodiments, the system includes a source of waste feed stock; a source of scCO₂; a source of at least one acid; a source of one or more organic ligands; a waste treatment reactor in communication with the source of waste feed stock, the source of scCO₂, and the source of at least one acid, the waste treatment reactor including a first outlet and a second outlet; a liquid delaminated waste stream in communication with the first outlet, the liquid delaminated waste stream including alkaline earth metals, transition metals, and/or rare earth elements (REEs), e.g., copper, cobalt, nickel, aluminum, calcium, magnesium, barium, strontium, manganese, vanadium, titanium, iron, zinc, neodymium, praseodymium, dysprosium, or combinations thereof; a solid delaminated waste stream in communication with the second outlet; a metal enrichment reactor in communication with solid delaminated waste stream and configured to perform a flotation separation process, gravity separation process, or combinations thereof on the solid delaminated waste stream, the metal enrichment reactor further comprising a third outlet; an enriched-metal solid delaminated waste stream in fluid communication with the third outlet; a leaching reactor in communication with the enriched-metal solid delaminated waste stream, liquid delaminated waste stream, or combinations thereof, and the source of one or more organic ligands, the leaching reactor including a solution including a plurality of metal-ligand complexes formed from a solvent including one or more organic ligands and at least a portion of the enriched-metal solid delaminated waste stream, liquid delaminated waste stream, or combinations thereof; and an electrochemical separation module configured to electrochemically separate a first product from the solution, the first product including a first metal from a first-metal-ligand complex of the plurality of metal-ligand complexes.

In some embodiments, the system includes a separation reactor in fluid communication with the leaching reactor and the source of scCO₂. In some embodiments, the separation reactor includes a rare-earth-element (REE) product stream including REE-ligand complexes from the solution. In some embodiments, the system includes a carbonation reactor in fluid communication with the liquid delaminated waste stream. In some embodiments, the system includes an alkaline earth metal product stream in communication with the carbonation reactor, the alkaline earth metal product stream including carbonated alkaline earth metals.

As discussed above, in some embodiments, the waste feed stock includes fly ash, iron slag, steel slag, red mud, printed circuit board, or combinations thereof. In some embodiments, the organic ligands include an acetic acid, a propionic acid, a valeric acid, a butyric acid, a carboxylic acid, a phosphoric acid, a primary amine compound, a quaternary amine compound, hydroxyoximes, organophosphorus acids, dialkylsulphoxides, diglycoamides, thiodiglycoamides, malonamides, diisopentylsulfides, pyridine-carboxamides, dialkyl/arylureas, or combinations thereof. In some embodiments, the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof.

Aspects of the present disclosure are directed to a method of recovering metals from waste materials. In some embodiments, the method includes treating a waste feed stock with supercritical CO₂ (scCO₂), at least one acid, and a grinding medium to produce a solid delaminated waste, a liquid delaminated waste, and a solid gold product; separating the solid delaminated waste from the liquid delaminated waste; isolating the solid gold product from the solid delaminated waste, the liquid delaminated waste, or combinations thereof; carbonating alkaline earth metals from the liquid delaminated waste to form a carbonated alkaline earth metal product; separating the solid delaminated waste into an enriched-metal solid delaminated waste and an enriched-polymer solid delaminated waste via a flotation separation process, gravity separation process, or combinations thereof; preparing a solution including the enriched-metal solid delaminated waste, liquid delaminated waste, or combinations thereof, and a solvent including one or more organic ligands; binding the one or more organic ligands to target metals in the solution to form a plurality of metal-ligand complexes; contacting the solution with scCO₂; and electrochemically separating at least a first product from the solution, including altering the pH of the solution to release metals from the metal-ligand complexes at different pHs. As discussed above, in some embodiments, the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof. In some embodiments, the waste feed stock includes fly ash, iron slag, steel slag, red mud, printed circuit board, or combinations thereof.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic representation of a system for recovering metals from waste materials according to some embodiments of the present disclosure;

FIG. 2 is a chart of a method for recovering metals from waste materials according to some embodiments of the present disclosure;

FIG. 3 is a chart of a method of recovering metals from waste materials according to some embodiments of the present disclosure;

FIG. 4 portrays images of untreated waste printed circuit boards in comparison with waste printed circuit boards treated with systems and methods according to some embodiments of the present disclosure;

FIG. 5 is a graph portraying changes in the flexural modulus waste printed circuit boards before and after treatment with systems and methods according to some embodiments of the present disclosure;

FIG. 6 is a graph portraying metal recovery rates with systems and methods according to some embodiments of the present disclosure;

FIG. 7 is a schematic representation of exemplary systems and methods for recovering metals from waste materials according to some embodiments of the present disclosure; and

FIG. 8 is a graph portraying leaching behaviors from waste printed circuit boards treated with systems and methods according to some embodiments of the present disclosure.

### DETAILED DESCRIPTION

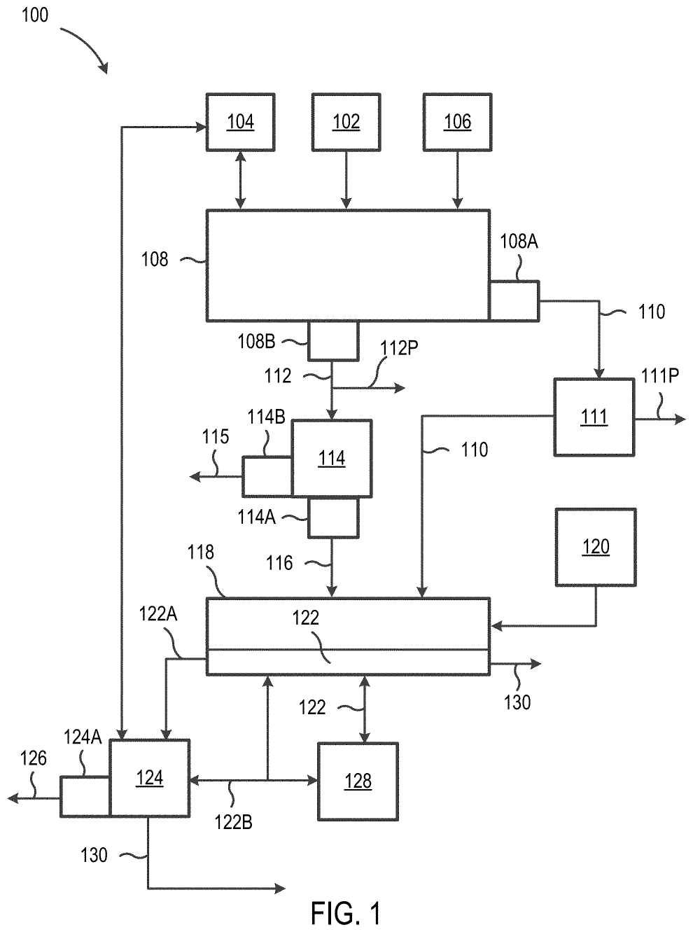

Referring now to FIG. 1, some embodiments of the present disclosure are directed to a system 100 for recovering metals from waste materials. As will be understood by those of ordinary skill in the art, the metals to be recovered from the waste materials depend at least in part on the source of the waste materials themselves. In some embodiments, the waste materials include industrial wastes, e.g., fly ash, iron and steel slag, red mud, etc.; municipal solid wastes, e.g., electronic wastes like printed circuit boards, spent batteries, magnets, computers, phones, waste-to-energy plant ashes, etc.; renewable energy wastes, e.g., end of life wind power systems, solar PV systems, wind turbine parts, etc.; combinations thereof, and the like. In some embodiments, the recovered metals are any target metals that form a portion of the waste materials, such as alkaline earth metals, transition metals, platinum group metals, rare earth elements (REEs), precious metals, or combinations thereof, as will be discussed in greater detail below.

Referring again to FIG. 1, in some embodiments, system 100 includes a source of waste material feed stock 102. As discussed above, source of waste feed stock 102 can include industrial wastes, municipal wastes, renewable energy wastes, etc. In some embodiments, the waste feed stock includes fly ash, iron slag, steel slag, red mud, printed circuit board, or combinations thereof. In some embodiments, system 100 includes a source of supercritical CO₂ (scCO₂) 104. In some embodiments, the scCO₂ is at or above the critical temperature and critical pressure of CO₂. In some embodiments, the scCO₂ is maintained at a temperature at or above about 31° C. In some embodiments, the scCO₂ is maintained at a temperature between about 35° C. and about 135° C. In some embodiments, the scCO₂ is maintained at a temperature between about 120° C. and about 135° C. In some embodiments, the scCO₂ is maintained at a pressure at or above about 74 bar. In some embodiments, the scCO₂ is maintained at a pressure between about 75 atm and about 150 atm. In some embodiments, the scCO₂ is maintained at a pressure between about 130 and about 160 bar.

In some embodiments, system 100 includes a source of at least one acid 106. The acids in source 106 are any suitable acid to leach one or more target metals from the waste feed stock in the presence of scCO₂. In some embodiments, the at least one acid includes H₂SO₄, hydrochloric acid (HCl), nitric acid, or combinations thereof. In some embodiments, the concentration of HCl is about 5 to about 30 wt %. In some embodiments, the initial concentration of HCl is about 20 to about 30 wt %. In some embodiments, the concentration of nitric acid is about 5 to about 30 wt %.

Still referring to FIG. 1, in some embodiments, system 100 includes at least one waste treatment reactor 108. In some embodiments, waste treatment reactor 108 is in communication, e.g., fluid communication via one or more conduits, with source of waste feed stock 102, source of scCO₂ 104, source of acid 106, or combinations thereof. In some embodiments, waste treatment reactor 108 includes at least a first outlet 108A and a second outlet 108B. In some embodiments, wastes from source 102 are treated via contact in waste treatment reactor 108 with scCO₂ from source of scCO₂ 104 and one or more acids from source of acid 106. The scCO₂-based solvent extracts metals such as nickel and other metals from the solid wastes, forming a solid delaminated waste and a liquid delaminated waste. In some embodiments, one component of the wastes that the scCO₂-based solvent does not extract is gold. In these embodiments, the metals that, e.g., bind gold to a surface substrate, can be extracted, allowing gold to be lifted from the surface of the waste feed stock and recovered as a solid product rather than dissolved species. In some embodiments, waste treatment reactor 108 or the treatment medium within the waste treatment reactor includes one or more internal grinding media to exfoliate the surface gold. In some embodiments, the one or more internal grinding media includes particles of aluminum, zirconia, glass, or combinations thereof. In some embodiments, the one or more internal grinding media is shaped as spheres, rods, triangles, or combinations thereof. In some embodiments, waste treatment reactor 108 or the treatment medium within the waste treatment reactor includes one or more oxidants. In some embodiments, the one or more oxidants include H₂O₂. In some embodiments, wastes from source 102 are treated via contact with an scCO₂ and one or more acids, and subsequently with one or more acids and one or more oxidants in a delamination step. In some embodiments, the initial concentration of acid, e.g., H₂SO₄, in the delamination step is between about 0.04 and about 30 wt %. In some embodiments, the initial concentration of oxidant, e.g., H₂O₂, in the delamination step is between about 0.04 and about 30 wt %.

The scCO₂ provides a sustainable mechanism to enhance the extraction of metal contents from waste sources such as printed circuit boards. First, scCO₂ can interact with various components of waste materials such as metal layers, fiberglass, and polymers, and lead to other physical and chemical changes. Second, binary or trinary scCO₂-acid solvent systems can decompose, extract, and separate halogen-containing polymeric compounds, e.g., Br and Cl in phenols and flame retardants, and reduce the emission of toxic gases during treatment. Third, the scCO₂-acid treatment can extract metals with a reduced amount of acid.

In some embodiments, a liquid delaminated waste stream 110 is withdrawn from waste treatment reactor 108 via first outlet 108A. Liquid delaminated waste stream 110 includes liquid delaminated wastes extracted from the waste feed stock provided to waste treatment reactor 108, e.g., a liquid waste stream with dissolved metal ions. In some embodiments, liquid delaminated waste stream 110 includes alkaline earth metals, transition metals, and/or rare earth elements (REEs), e.g., copper, cobalt, nickel, aluminum, calcium, magnesium, barium, strontium, manganese, vanadium, titanium, iron, zinc, neodymium, praseodymium, dysprosium, or combinations thereof. In some embodiments, one or more components of liquid delaminated waste stream 110 are carbonated after removal from waste treatment reactor 108. In some embodiments, alkaline earth metals present in liquid delaminated waste stream 110 such as calcium, magnesium, barium, strontium, etc., are carbonated to form an alkaline earth metal product. In some embodiments, liquid delaminated waste stream 110 is provided to a carbonation reactor 111, where the alkaline earth metals are carbonated. These carbonated alkaline earth metals can then be removed from carbonation reactor 111 as alkaline earth metal product stream 111P. The carbonated alkaline earth metal products can then be used for a wide range of applications including construction materials, paper fillers, plastic fillers, etc. Since CO₂ is being converted to products by reacting with metals such as Ca and Mg, this process may be eligible for carbon credits and considered as a negative emission technology. In some embodiments, one or more REEs are precipitated out of liquid delaminated waste stream 110 for subsequent purification and recovery. In some embodiments, the one or more REEs are precipitated via contact of liquid delaminated waste stream 110 with a pH neutralizing additive. In some embodiments, the pH neutralizing additive includes sodium hydroxide, ammonium hydroxide, or combinations thereof. In some embodiments, the concentration of the pH neutralizing additive is between about 0.1M and about 20M.

Referring again to FIG. 1, in some embodiments, a solid delaminated waste stream 112 is withdrawn from waste treatment reactor 108 via second outlet 108B. In some embodiments, the solid delaminated waste, e.g., solid delaminated waste stream 112, can be collected and ground, e.g., prior to metal enriching, treatment with the solvent, etc., as will be discussed in greater detail below. The energy for such grinding is low since leaching and removal of metals such as calcium, magnesium, barium, strontium, etc., can create a large pore network in the solid wastes. In some embodiments, a gold product, e.g., solid gold product 112P, is isolated from the solid delaminated waste, e.g., from solid delaminated waste stream 112, as a separate outlet from waste treatment reactor 108, etc., or combinations thereof. In some embodiments, solid delaminated waste stream 112 includes silver, one or more platinum group metals, e.g., platinum, osmium, palladium, rhodium, ruthenium, iridium, etc., or combinations thereof.

In some embodiments, solid delaminated waste stream 112 is provided to a metal enrichment reactor 114. In some embodiments, metal enrichment reactor 114 treats solid delaminated waste stream 112 via one or more processes to produce an enriched-metal solid delaminated waste and an enriched-polymer solid delaminated waste. In some embodiments, the treatment processes performed in the metal enrichment reactor 114 include a flotation separation process, gravity separation process, or combinations thereof, as will be understood by those of ordinary skill in the art. In some embodiments, the collector in the flotation process includes xanthate. In some embodiments, the frother in the flotation processes includes methyl isobutyl carbinol, pine oil, or combinations thereof.

In some embodiments, an enriched-metal solid delaminated waste stream 116 is withdrawn from metal enrichment reactor 114 via a third outlet 114A. In some embodiments, enriched-metal solid delaminated waste stream 116 includes silver, one or more platinum group metals, e.g., platinum, osmium, palladium, rhodium, ruthenium, iridium, etc., or combinations thereof. In some embodiments, an enriched-polymer delaminated waste stream 115 is also withdrawn from metal enrichment reactor 114, e.g., via a fourth outlet 114B. In some embodiments, at least a portion of solid delaminated waste stream 112 is provided to a leaching reactor 118. In some embodiments, at least a portion of enriched-metal solid delaminated waste stream 116 is provided to a leaching reactor 118. In some embodiments, at least a portion of liquid delaminated waste stream 110 is provided to leaching reactor 118. In some embodiments, at least a portion of liquid delaminated waste stream 110 is provided to a leaching reactor 118 after removal of alkaline earth metal product stream 111P. In some embodiments, leaching reactor 118 is also in communication with a source of one or more organic ligands 120. In some embodiments, at least a portion of solid delaminated waste stream 112, enriched-metal solid delaminated waste stream 116, liquid delaminated waste stream 110, or combinations thereof, and one or more organic ligands from source 120 are contacted in leaching reactor 118. In some embodiments, a portion of enriched-metal solid delaminated waste stream 116 and one or more organic ligands from source 120 form a solution 122 in leaching reactor 118. In some embodiments, a portion of liquid delaminated waste stream 110 and one or more organic ligands from source 120 form solution 122 in leaching reactor 118. In some embodiments, a portion of enriched-metal solid delaminated waste stream 116 and a portion of liquid delaminated waste stream 110 and one or more organic ligands from source 120 form solution 122 in leaching reactor 118. In some embodiments, at least a portion of solid delaminated waste stream 112, enriched-metal solid delaminated waste stream 116, liquid delaminated waste stream 110, or combinations thereof, and one or more organic ligands from source 120 form solution 122 in leaching reactor 118.

The organic ligands in solution 122 bind to the target metals remaining in, e.g., enriched-metal solid delaminated waste stream 116, such as transition metals or REEs, to form metal-ligand complexes. In some embodiments, the organic ligands are selected so that they are soluble in water but not soluble in scCO₂. In some embodiments, the organic ligands include an acetic acid, a propionic acid, a valeric acid, a butyric acid, a carboxylic acid, a phosphoric acid, a primary amine compound, a quaternary amine compound, hydroxyoximes, organophosphorus acids, dialkylsulphoxides, diglycoamides, thiodiglycoamides, malonamides, diisopentylsulfides, pyridine-carboxamides, dialkyl/arylureas, or combinations thereof. In some embodiments, the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof. In some embodiments, the organic ligands include Cyanex923, D2EHPA, tributyl phosphate, phenanthroline, TriNOx, hydroxamic acid, glutarimide-dioxime, carbamoylmethylphosphine, diglycoamide, alkylated triazinyl pyridines, or combinations thereof, e.g., for recovery of REEs. In some embodiments, the organic ligands include hydroxyoximes, Acorga M5640, carboxylic acids, organophosphorus acids, D2EHPA, Cyanex 301, LIX 63, or combinations thereof, e.g., for recovery of metals such as transition metals. In some embodiments, the organic ligands include dialkylsulphoxides, diglycoamides, thiodiglycoamides, malonamides, diisopentylsulfides, pyridine-carboxamides, dialkyl/arylureas, or combinations thereof, e.g., for recovery of platinum group metals.

In some embodiments, at least a portion of solution 122, identified as 122A, is provided to a separation reactor 124. In some embodiments, separation reactor 124 is also in communication with source of scCO₂ 104. The mixing of the metal-bearing solution 122A and scCO₂ forms a solution that has a lower REE solubility. The solute, which includes REE-ligand complexes, becomes supersaturated and thus precipitates out. In some embodiments, the REE precipitates as REE oxides and the other metals stay in the solution phase. In some embodiments, scCO₂ utilized by system 100 is recycled throughout the overall system to minimize energy output. In some embodiments, an REE product stream 126 including REE-ligand complexes from solution 122A is withdrawn from separation reactor 124 via a fifth outlet 124A, thus separating it from remaining solution 122B, which can also be withdrawn from separation reactor 124 for further processing or further processed in situ, as will be discussed in greater detail below.

In some embodiments, system 100 includes an electrochemical separation module 128. Electrochemical separation module 128 includes any combination of components configured to electrochemically separate a first metal from solution 122 and/or 122B to form a product stream 130, e.g., including one or more pairs of electrodes, membranes, pH controllers, etc. In some embodiments, as discussed above, solution 122 and/or 122B include a plurality of metal-ligand complexes. In some embodiments, product stream 130 includes at least a first metal that has been separated from a first metal-ligand complex from the plurality of metal-ligand complexes. The organic ligands have high affinity for target metals such as REEs, and their pKa values show the protonated pH for the ligands, which indicate the pH limit to deactivate the ligands. Using these pH behaviors, some embodiments of the present disclosure control the complexation reactions between ligands and metals and REEs in order to capture and release metals from the metal-ligand complexes as needed in the form of product stream 130 and additional products depending on the composition of solution 122. In some embodiments, the activity of ligands is controlled by altering pH to stepwise release different metals from metal-ligand complexes as separate, dissociated metal products in product 130, keeping the purity of the separated metals high. In these embodiments, additional metals e.g., Cu, Co, Ni, etc., present, e.g., in enriched-metal solid delaminated waste stream 116, are selectively recovered from solution 122 via electrochemical separation. In some embodiments, product stream 130 includes at least a first metal-ligand complex that has been separated from the plurality of metal-ligand complexes. In some embodiments, electrochemical separation is performed in leaching reactor 118. In some embodiments, electrochemical separation is performed in separation reactor 124. In some embodiments, system 100 is integrated into an established waste treatment process.

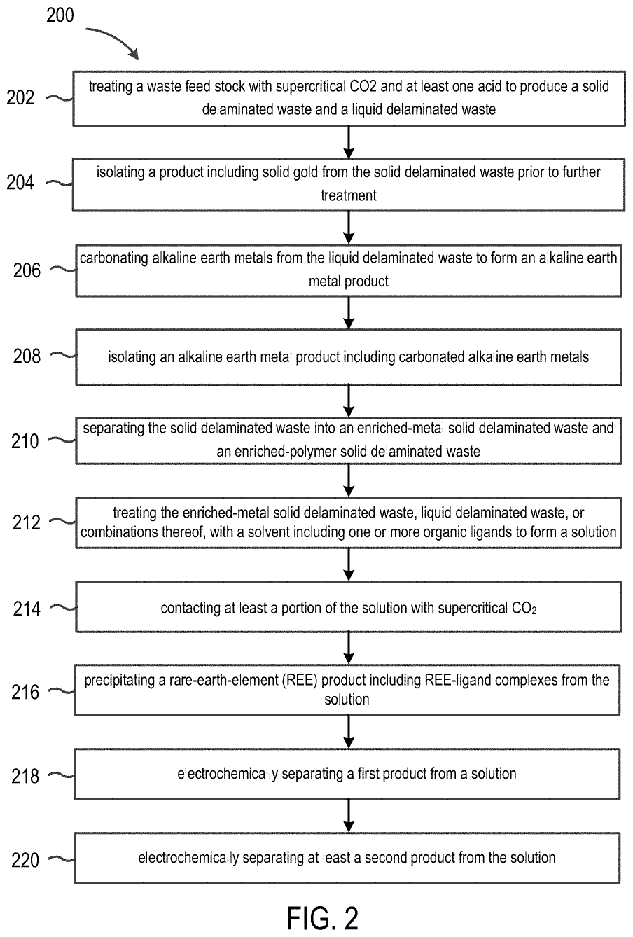

Referring now to FIG. 2, some embodiments of the present disclosure are directed to a method 200 of recovering metals from waste materials. At 202, a waste feed stock is treated with scCO₂ and at least one acid to produce a solid delaminated waste and a liquid delaminated waste. As discussed above, in some embodiments, the waste feed stock includes industrial wastes, municipal wastes, renewable energy wastes, etc. In some embodiments, the waste feed stock includes fly ash, iron slag, steel slag, red mud, printed circuit board, or combinations thereof. In some embodiments, the liquid delaminated waste includes alkaline earth metals, transition metals, and/or rare earth elements (REEs), e.g., copper, cobalt, nickel, aluminum, calcium, magnesium, barium, strontium, manganese, vanadium, titanium, iron, zinc, neodymium, praseodymium, dysprosium, or combinations thereof.

In some embodiments, at 204, a solid gold product is isolated from the solid delaminated waste prior to further treatment of the solid delaminated waste via any suitable process, e.g., size-exclusion separation, gravity separation, etc. In some embodiments, isolating step 204 includes contacting the solid delaminated waste with an internal grinding medium.

In some embodiments, at 206, alkaline earth metals from the liquid delaminated waste are carbonated to form an alkaline earth metal product. In some embodiments, the alkaline earth metals are carbonated 206 via reaction with CO₂, e.g., captured from the environment, waste materials, etc., or combinations thereof. In some embodiments, the partial pressure of the CO₂ is between about 15% and 100%. At 208, an alkaline earth metal product including carbonated alkaline earth metals is isolated.

Still referring to FIG. 2, at 210, in some embodiments, the solid delaminated waste is separated into an enriched-metal solid delaminated waste and an enriched-polymer solid delaminated waste. In some embodiments, separating step 210 includes a flotation separation process, gravity separation process, or combinations thereof. At 212, treating the enriched-metal solid delaminated waste, liquid delaminated waste, or combinations thereof, are treated with a solvent including one or more organic ligands to form a solution. As discussed above, the organic ligands configured to bind at least one target metal in the enriched-metal solid delaminated waste liquid delaminated waste, etc. In some embodiments, the organic ligands include an acetic acid, a propionic acid, a valeric acid, a butyric acid, a carboxylic acid, a phosphoric acid, a primary amine compound, a quaternary amine compound, hydroxyoximes, organophosphorus acids, dialkylsulphoxides, diglycoamides, thiodiglycoamides, malonamides, diisopentylsulfides, pyridine-carboxamides, dialkyl/arylureas, or combinations thereof. In some embodiments, the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof.

In some embodiments, at 214, at least a portion of the solution is contacted with scCO₂. At 216, an REE product including REE-ligand complexes is precipitated from the solution.

At 218, a first product is electrochemically separated from the solution, the first product including a first metal from the first-metal-ligand complex. In some embodiments, at 220, at least a second product is electrochemically separated from the solution, the second product including a second metal from the second-metal-ligand complex. In some embodiments, electrochemically separating steps 218 and 220 include altering the pH of the solution to release the second metal from the second-metal-ligand complex. As discussed above, in some embodiments, the electrochemical separation can be performed via any suitable electrochemical apparatus, e.g., including one or more pairs of electrodes, membranes, pH controllers, etc. In some embodiments, the first metal and the second metal are different.

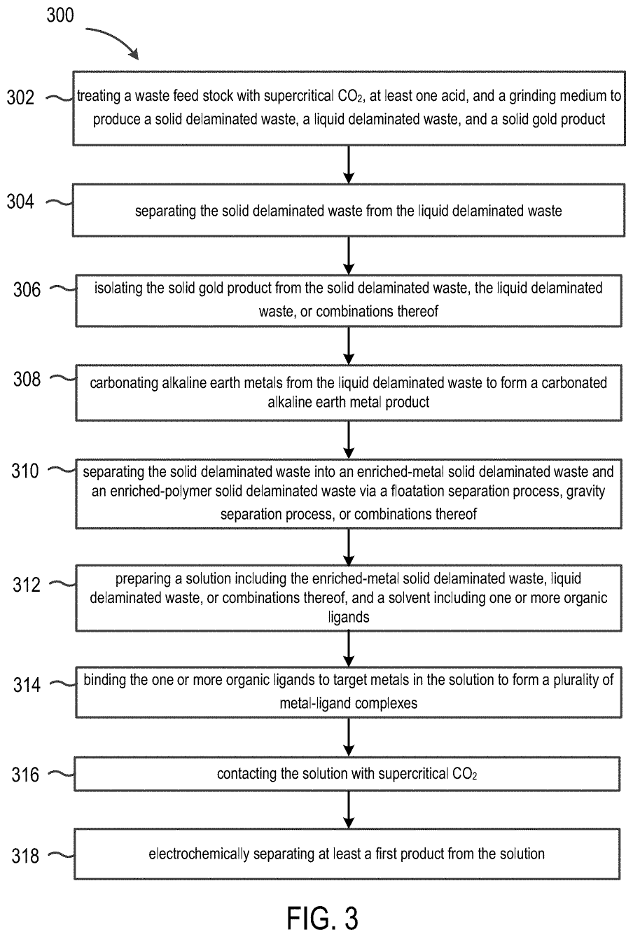

Referring now to FIG. 3, some embodiments include a method 300 of recovering metals from waste materials. In some embodiments of method 300, at 302, a waste feed stock is treated with scCO₂, at least one acid, and a grinding medium to produce a solid delaminated waste, a liquid delaminated waste, and a solid gold product. As discussed above, in some embodiments, the waste feed stock includes fly ash, iron slag, steel slag, red mud, printed circuit board, or combinations thereof. At 304, the solid delaminated waste is separated from the liquid delaminated waste. At 306, the solid gold product is isolated from the solid delaminated waste, the liquid delaminated waste, or combinations thereof. At 308, alkaline earth metals from the liquid delaminated waste are carbonated to form a carbonated alkaline earth metal product, which can then be removed from the liquid delaminated waste. At 310, the solid delaminated waste is separated into an enriched-metal solid delaminated waste and an enriched-polymer solid delaminated waste via a flotation separation process, gravity separation process, or combinations thereof.

At 312, a solution including the enriched-metal solid delaminated waste, liquid delaminated waste, or combinations thereof, and a solvent including one or more organic ligands is prepared. As discussed above, in some embodiments, the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof. At 314, the one or more organic ligands are bound to target metals in the solution to form a plurality of metal-ligand complexes.

In some embodiments, at 316, at least a portion of the solution is contacted with scCO₂ to produce an REE product including REE-ligand complexes. At 318, at least a first product is electrochemically separated from the solution, the first product including a first metal from a first-metal-ligand complex of the plurality of metal-ligand complexes. In some embodiments, electrochemically separating step 318 includes altering the pH of the solution to release target metals from metal-ligand complexes at different pHs.

### Examples

There are a number of oxidative acids that can be used to leach metals from waste printed circuit boards (WPCBs), such as HCl and HNO₃, and H₂SO₄ and H₂O₂ were selected in this embodiment since they have been reported to be the most cost effective for Cu leaching from WPCBs. All the experiments were performed using H₂SO₄/H₂O₂ to be consistent and to isolate the effect of scCO₂. The scCO₂-acid treatment process investigated in this example consisted of two stages: (1st stage) the pre-treatment of WPCBs using the scCO₂-acid system and (2nd stage) metal leaching using a solvent containing acid (H₂SO₄) and oxidant (H₂O₂). Since the composition of WPCBs is highly heterogeneous, the connector part of WPCBs, which contains both Cu and precious metals, e.g., Au, was selected. LCD screen modules were collected and manually dismantled to collect the WPCB connectors. The WPCB connector samples were cut to a planner size of 25 mm×4 mm.

During the first stage of treatment, the WPCB sample was treated using scCO₂ and 1 M H₂SO₄ in a Parr A5179 high pressure high temperature reactor, coupled with a Parr 4848 reactor controller for temperature control and monitoring. A Teledyne ISCO model 500 D syringe pump was used to supply scCO₂ to the reactor. 10 mL of 1M H₂SO₄ and WPCB samples were placed inside the batch reactor, and the system was first flushed with CO₂ in order to remove any oxygen. Next, the temperature and pressure of the system were adjusted to the desired values (150 bar and 120° C.), and maintained during the treatment while agitating the mixture at a rate of 250 rpm. Both liquid and solid samples were analyzed and the solid samples were collected for the second stage treatment.

The second stage of treatment, mainly targeting the metal extraction, employed 2 M H₂SO₄ at room temperature in the presence of the oxidizer, 0.2 M hydrogen peroxide (H₂O₂). After each stage of treatment, the samples were collected.

The liquid products from both stages were analyzed using inductively coupled plasma-optical emission spectrometry (ICP-OES, Model 5110, Agilent, USA) to obtain the extents of metal extractions. The changes in the morphological, mechanical, and surface chemical properties of the delaminated solids and solid residue were determined using various characterization techniques. To accurately determine the total extraction efficiencies of various metals the solid residue and delaminated solids were ground and fully digested using aqua regia for 48 hours, and the resulting solutions were analyzed using ICP-OES.

Flexural modulus was used to characterize and quantify the changes in the mechanical strength of WPCBs. The mechanical property measurements were conducted using a DMA 850 Dynamic Mechanical Analyzer (TA Instruments, USA). The changes in the mechanical strength were studied due to its relation to the energy consumption during physical shredding and grinding that are often associated with e-waste pre-treatment. For investigating the surface chemical changes, X-ray photoelectron spectroscopy (XPS) was used to identify both metals and non-metals on solid products obtained from each treatment stage. The cross-sectional elemental compositions were determined using a Bruker XFlash® 6|30 Energy-dispersive X-ray spectroscopy (EDS) detector (MA, USA) coupled with SEM analysis. The surface characterization results were combined with the ICP-OES data to provide insights into the metal extraction mechanisms in the proposed two-step scCO₂-acid WPCB treatment process.

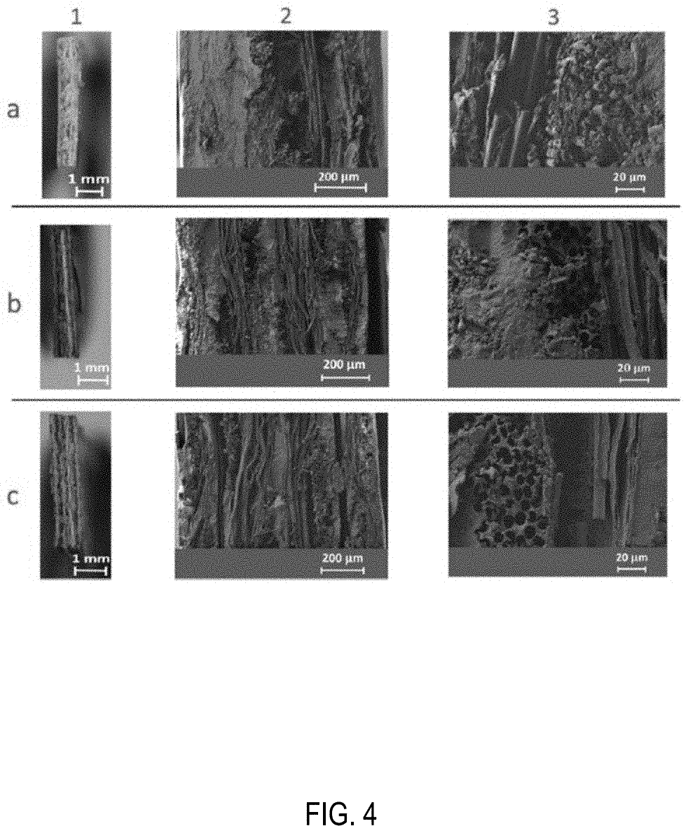

Referring now to FIG. 4, the physical and chemical changes of the planar surface of the WPCB connector are important in terms of Au recovery but most of the Cu (a second valuable metal in WPCBs) is embedded in the inner layers of WPCB connectors. Thus, exposed inner cross-sectional surfaces of the WPCB connector were investigated. Both close-up photos and SEM images show the layered structures of WPCB connectors and how they were altered during each treatment step.

Noticeable differences in the cross-sectional views of the WPCB connector include swelling, disordering of structures, and the development of large pores. The thickness of the WPCB connector increased by nearly 30 vol %, e.g., see A1 of 0.66 mm (untreated) and Cl of 0.84 mm (after the second stage of treatment). The internal structure of the untreated WPCB connector includes two forms of structures, solid and rods, with relatively smooth textures (see A2 and A3). After the first stage of treatment using scCO₂ and H₂SO₄, the formation of micron-scale pores in the cross-sectional region was observed (see A3 compared to B3). The formation of these pores was relevant to acid penetration into the metal-polymer matrix in the presence of scCO₂.

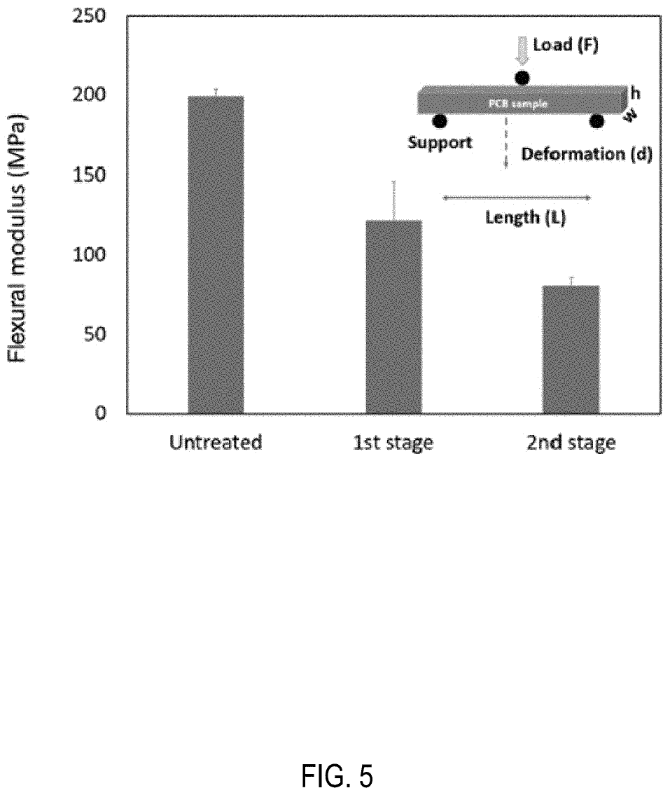

Referring now to FIG. 5, in addition to enhanced extraction and separation of metals, another proposed advantage of the scCO₂-based WPCB treatment scheme was the reduction in the grinding energy. Waste electrical and electronic equipment including WPCBs are complex in terms of materials, and their polymeric and metallic parts make them less brittle and more ductile. The formation of porous structures within the internal volume of WPCBs and potential chemical alteration of polymers in the presence of scCO₂ and heat consistent with embodiments of the present disclosure were proposed to change their mechanical strength.

$$Flexural modulus = \frac{{L}^{3} F}{4 {wh}^{3} d} \qquad ( 1 )$$

One of the ways to characterize the mechanical strength of ductile materials under high shear treatment, such as shredding, is the use of the flexural modulus. Equation (1) can be used to estimate the flexural modulus as a function of the given load and the measured deformation of the material. As shown in FIG. 5, the measured flexural modulus was reduced by up to 60% after the two-stage scCO₂-based WPCB treatment. Thus, the use of size reduction in the embodiments of the present disclosure can be included without the energy requirements associated with traditional WPCB treatment systems and methods. Metal recovery from scCO₂/acid treated WPCBs

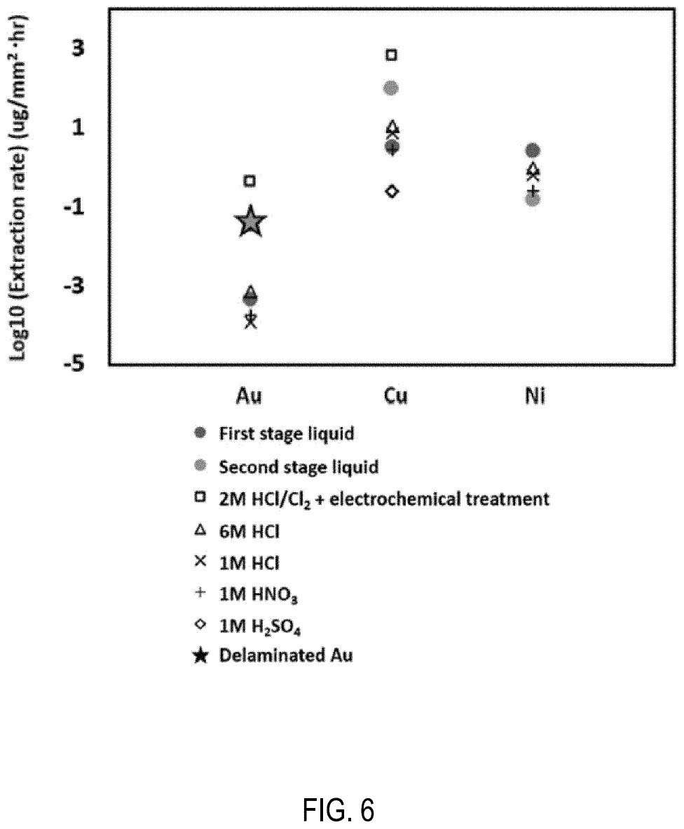

In this exemplary embodiment, metals in WPCBs were recovered in two phases, delaminated solids and dissolved species in the liquid phase. The target metals in this example were Au, Ni, and Cu. As mentioned, these metals are disproportionately distributed throughout WPCBs, but on average, they accounted for 0.01 wt %, 1.1 wt %, and 23 wt % in the WPCB samples, respectively. As expected, Au was recovered as solids in the solid delaminated waste, while Cu was recovered in the liquid delaminated waste. FIG. 6 summarizes the recovery rates of the metals (Au, Cu, and Ni) and those rates are compared to those reported in the literature for solvents with different green factors. Without wishing to be bound by theory, the extraction rates of Cu and Ni were favored in different stages of the process. Cu was selectively extracted during the second stage of treatment while Ni was mostly extracted in the first stage of scCO₂/acid pre-treatment.

Again, without wishing to be bound by theory, during scCO₂/acid pre-treatment, the high extent of Ni recovery may be because Ni mostly exists on the surface of the WPCB along with Au. Further, the extraction of Ni seems to influence the leaching behavior of other metals in the subsequent stage. Unlike the metal recovery from natural ores, the e-waste processing technologies are challenged by the interferences between different metal leaching and separation processes. The selective extraction of Ni and Au during the first stage of treatment and recovery of Au as delaminated solids illustrates the benefits of and potential opportunities for the scCO₂-acid pre-treatment process.

During hydrometallurgical processing using an acid-oxidizer mixture, Cu extraction was significantly enhanced using the mixture and additional debonding of Au coating was observed. The black star in FIG. 6 marks the delamination rate of Au from the surface of WPCB, i.e., solid separation product.

Still referring to FIG. 6, the extraction rates for Cu and Ni were higher than most reported values in the literature that investigated the extraction of metals from unground WPCB pieces. This was the case even when compared to the study with the most concentrated acid solvent (6M HCl). Particularly, the Ni extraction from the WPCB surface was very effective. Over 87.3% of Ni was extracted during the first stage scCO₂/acid treatment, and after the second stage, nearly 97.4% of Ni was extracted from WPCBs. On the other hand, the extraction of Au was favored in the second stage. Its leaching was minimal in the first stage, but the overall extent of Au recovery after the second stage was nearly 96.6%. Since Au was recovered as delaminated solids, the separation of Au and base metals was straightforward. These results show that Ni and Au can be selectively extracted from WPCBs.

The time required for full recovery of metals in this study was significantly shorter than the literature values obtained using oxidative acids, i.e., HCl and HNO₃ for 10 hours, and weak organic acids, i.e., acetic acid and citric acid for 100 hours. As shown in FIG. 6, the only prior study that performed better in terms of metal recovery was the electrochemical treatment of WPCB using HCl/Cl₂ (black open square). However, the electrochemical treatment continuously produced strong oxidant (Cl₂) in situ during the metal extraction and while this allowed the rapid extraction of Au and Cu, and the recovered Au was in the form of dissolved species in the liquid phase, whereas the process according to this embodiment of the disclosure recovered Au as solids. It is also important to consider the sustainability of each treatment process. Although chlorine leaching tends to have faster leaching kinetics, the use of strong oxidant such as Cl₂ can come with extensive corrosion protection and emission controls for safety.

As discussed earlier, the selective extraction of Au as delaminated solids is one of the benefits of and potential opportunities for scCO₂-acid treatment. Other studies have reported that 50% to 90% of precious metals including Au were lost through the plastic and particulate waste streams during the size reduction and physical separation of WPCBs, e.g., shredding, grinding, and density separation. Since Au mainly exists on the surface layer of WPCBs, recovering it before shredding and grinding would be more effective instead of diluting it into the other waste streams.

In a further exemplary embodiment, a process was performed for leaching Cu and other metals in separate streams from pieces of waste PCB with supercritical CO₂ (scCO₂) and aqueous acid. Through the synthesis of metal and polymer laminates as “model PCB” to reduce the complexity of PCB samples, the effects of scCO₂ with various co-solvents were investigated in a high-pressure, high-temperature reactor. In this exemplary embodiment, printed circuit board scrap was collected from waste computers in a local scrap collection. The waste PCB was cut into small pieces ranging in size between 0.2-1 cm² lateral area. A portion of the waste PCB was ground into fine particles (<1 mm in size) in a Blendtec Designer 725 blender. The metal composition of the PCB was determined in two ways: 1) dissolving the finely crushed waste PCB in concentrated, heated H₂SO₄ solution (Certified ACS Plus, Fisher Chemical) and H₂O₂ (30 wt % w/inhibitor, Sigma-Aldrich) for >24 h; and 2) pyrolyzing the small pieces of waste PCB at 500° C. and then dissolving the char in concentrated, heated acidic solution for >24 h. From the results, the metal component of the PCB samples was determined to include the following base metals: Cu 20%, Al 2%, Fe 2%, and Ni 3%.

Model PCB laminate samples were prepared using Cu foil (0.1 mm thick, Puratronic, 99.999% (metals basis), Alfa-Aesar) and polycarbonate (sheets of 1.0 mm thickness, Goodfellow). The laminated, layered composites (polymer/metal/polymer) were made on a hot press (Carver Model 4122) at a temperature of 166° C., above the glass transition temperature, T_{g}, of the polycarbonate. 8 mm-diameter disks of Cu foil were cut out and sandwiched between two (4 cm×7.5 cm) sheets of polycarbonate, and a load of 1.6 t was applied to press the sheets together, encapsulating the Cu disks. The desired thickness of the model PCB samples was 1.1-1.3 mm, comparable with the thickness of real PCB waste. Once the desired thickness was achieved in the hot press, the sample was removed for cool-down and individual samples were punched out as 12 mm-diameter disks. The Cu foil was completely encased between the two polycarbonate layers, and the average thickness of the model PCB samples was 1.2 mm.

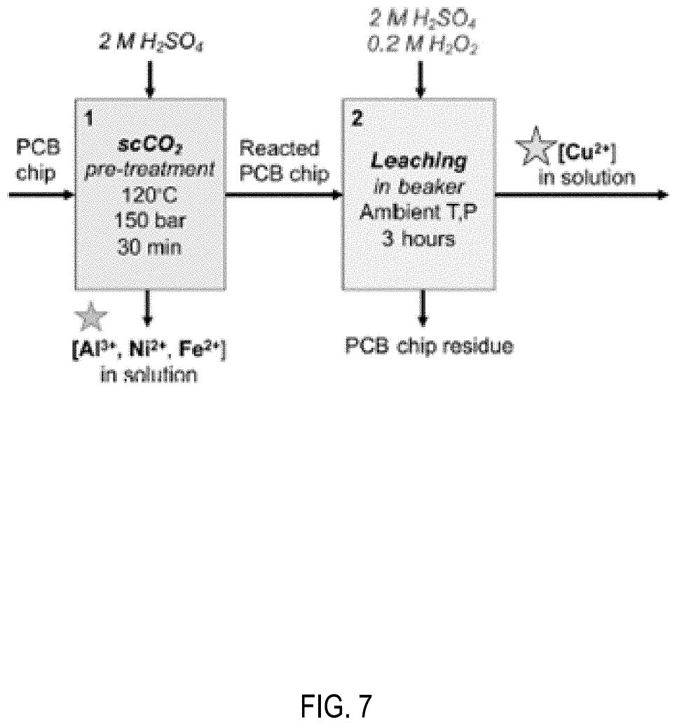

Referring now to FIG. 7, the model PCB samples and small pieces of actual waste PCB were treated with scCO₂ in a high-pressure, high-temperature (P, T) reactor (Model 4597 Micro Reactor, max pressure=340 atm, max temperature=350° C., Parr Co.) connected to a syringe pump (Model 500D syringe pump, Teledyne ISCO). The treatment with scCO₂ was conducted at a temperature of 120° C. and a pressure of 148 atm with a stirring rate of 600 rpm.

The solid to liquid ratio in the reactor was controlled at 25 g PCB/1 L of solution, where the total volume of solution in the reactor was maintained at 10 mL. Sulfuric acid solution with a concentration of 2 M H₂SO₄ was prepared using deionized water and H₂SO₄ (Certified ACS Plus, Fisher Chemical). For the subsequent leaching process, experiments were conducted at ambient temperature and pressure in a 100 mL beaker on a digital, magnetic stirring plate with stir speed set to 300 rpm. The leaching solution was prepared using 2 M H₂SO₄ solution and 0.2 M H₂O₂ prepared from hydrogen peroxide solution (30 wt % w/inhibitor, Sigma-Aldrich). The total volume of leaching solution was controlled at 10 mL and the solid to liquid ratio was kept at 25 g PCB/1 L. Once leaching was completed, the solution was collected using a 10 mL syringe connected to a 2.5 μm filter to ensure the leached solution was free of sample residue. The leached solutions were then analyzed using Inductively Coupled Plasma-Optical Emission Spectrometry ICP-OES (Agilent 720) to determine the fractions of Cu, Fe, Al, and Ni extraction. Characterization of the model and actual waste PCB was performed using Differential Scanning calorimetry, DSC (TA Instruments DSC250), and Scanning Electron Microscopy, SEM (Zeiss Sigma VP).

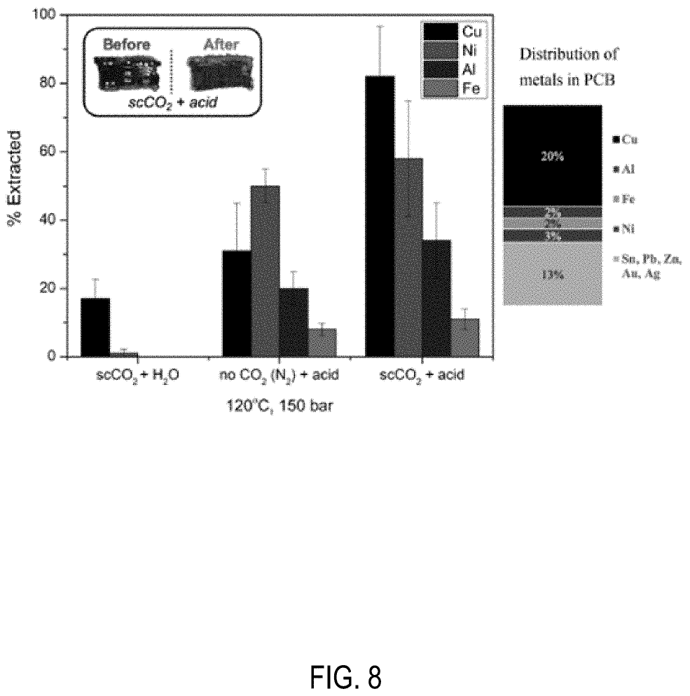

Referring now to FIG. 8, three variations of the pre-treatment step were investigated, keeping the pre-treatment temperature and pressure conditions constant at 120° C. and 148 atm. The leaching step, e.g., to extract Cu, was kept consistent in all three cases. In the first case, only water was used as the co-solvent in the exposure to scCO₂, and the total volume of solution, 10 mL, was maintained. After this treatment, no visible changes were seen on the PCB, the plastics appeared intact, and the surface appeared smooth and seemingly unaffected. The extent of Cu extraction obtained from ICP analysis was only 17% in this first case. In the second case, CO₂ was removed from the pre-treatment and replaced with N₂ at the same temperature and pressure conditions. The solvent system contained 2 M H₂SO₄. ICP analysis revealed a marginal improvement over the pretreatment with scCO₂ and water, yielding 31% Cu extracted. Finally, pre-treatment of scCO₂ and 2 M H₂SO₄ was investigated. The leached solution from the treatment was analyzed and 82% Cu was extracted. In some embodiments, Al, Fe, and Ni can be extracted in a separate stream from the Cu, with Cu is purely extracted after the 3-hour leaching process and Al, Fe, and Ni are extracted after the pretreatment with scCO₂.

Processes utilizing scCO₂ as a pre-treatment consistent with embodiments of the present disclosure proved to be effective in the leaching of Cu from small pieces of actual waste PCB. Nearly 100% copper extraction is obtained in under 4 hours without energy-intensive physical processing. Embodiments of the present disclosure utilizing scCO₂-based treatment process can eliminate the grinding and separation steps used in the traditional processing of e-waste, specifically PCBs. When scaled-up, the shredded waste PCBs can be placed directly inside of a large reactor. Existing leaching methods for small pieces of waste PCB require at least 8 hours of leaching at an elevated temperature of 85° C. In the embodiments of the instant disclosure, pre-treatment time of only 30 min in the high-temperature and high-pressure reactor is significant, as the residence time has been substantially decreased from the 3-6-hour residence time of conventional schemes with scCO₂.

Delamination processes using scCO₂ and water required a minimum of 3 hours and further processing steps afterwards. Embodiments of the present disclosure, by comparison, shorten the residence time and keep the PCB structure intact, with only the metals leached out from the board. There is no toxic release of flame retardants and hazardous gasses and there is no generation of byproducts. The separation of PCB into the plastic, metal, and glass fiber components can be bypassed entirely. From the materials perspective, an intact PCB could simplify recycling. Furthermore, with Cu nearly fully leached out, there is increased access to precious metals in the waste and therefore the extraction of Au and Ag can be improved. In some embodiments, gold could be extracted in a secondary leaching process using solvents such as thiosulfate solution, thiourea, hydrochloric acid, or aqua regia; and/or separated physically since the PCB is structurally weakened by the pre-treatment with scCO₂ and acid. In some embodiments, this type of sustainable, the Au-containing sections of the PCB for a targeted via physical separation for an improved process of recovering the precious metal.

In terms of the corrosivity and toxicity of the solvent, the volume of acid utilized is relatively small, with a lower solid to liquid ratio compared to that of current processes. The pre-treatment of pieces of waste PCB with scCO₂ is also advantageous because it does not require special additives. Recently reported pre-treatments utilize expensive and potentially hazardous additives, such as NaOH and citric acid, in sizable amounts. Specifically, the pre-treatment method with citric acid involves a large amount of concentrated hydrogen peroxide, 1.76 M H₂O₂, which is highly reactive and quite hazardous.

Lastly, by incorporating scCO₂ as a green solvent and eliminating the intensive mechanical processing steps, opportunities towards sustainability are created. With respect to the economic and energy benefits of minimizing mechanical processing, a study conducted on an e-waste recycling facility in California showed that size reduction, dismantling, and separation account for approximately 25% of the operating costs associated with processing e-waste. Energy makes up roughly 20% of the operating costs from size reduction, and labor and equipment make up the rest of those costs. From these estimates, systems and methods of the present disclosure have the potential to reduce up to 25% of the operating costs at an e-waste recycling facility, and in turn save energy and reduce labor and equipment costs.

Systems and methods of the present disclosure also advantageously integrate scCO₂-facilitated hydrometallurgical separations with electrochemical technology that broadens the scope of materials and metals that can be recovered from existing waste streams such as e-waste and ashes. Some embodiments of the present disclosure obtain high recovery and/or refinement (>90-95%) of rare earth elements and metals, particularly copper, gold and nickel, in high purity streams due to the electrochemical separation of metals from metal-ligand complexes via pH-controlled stepwise release. These embodiments can also be used to characterize waste ashes to understand their physicochemical properties, while minimizing the disadvantageous environmental impacts of existing systems and methods.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method of recovering metals from waste materials, comprising:
treating a waste feed stock with supercritical CO₂ (scCO₂) and at least one acid to produce a solid delaminated waste and a liquid delaminated waste;
separating the solid delaminated waste into an enriched-metal solid delaminated waste and an enriched-polymer solid delaminated waste;
treating the enriched-metal solid delaminated waste, liquid delaminated waste, or combinations thereof, with a solvent including one or more organic ligands to form a solution, the organic ligands configured to bind at least one target metal in the enriched-metal solid delaminated waste to form at least a first-metal-ligand complex; and
electrochemically separating a first product from the solution, the first product including a first metal from the first-metal-ligand complex.

2. The method according to claim 1, further comprising:
electrochemically separating at least a second product from the solution, the second product including a second metal from the second-metal-ligand complex,
wherein the first metal and the second metal are different.

3. The method according to claim 2, wherein electrochemically separating at least a second product from the solution includes altering the pH of the solution to release the second metal from the second-metal-ligand complex.

4. The method according to claim 1, wherein separating the solid delaminated waste into an enriched-metal solid delaminated waste and an enriched-polymer solid delaminated waste includes a flotation separation process, gravity separation process, or combinations thereof.

5. The method according to claim 1, further comprising:
isolating a product including solid gold from the solid delaminated waste prior to treatment with the solvent.

6. The method according to claim 5, wherein isolating a product including solid gold from the solid delaminated waste prior to treatment with the solvent includes:
contacting the solid delaminated waste with an internal grinding medium.

7. The method according to claim 1, wherein the liquid delaminated waste includes alkaline earth metals, transition metals, rare earth elements (REEs), or combinations thereof.

8. The method according to claim 7, further comprising:
carbonating alkaline earth metals from the liquid delaminated waste to form an alkaline earth metal product; and
isolating an alkaline earth metal product including carbonated alkaline earth metals.

9. The method according to claim 1, wherein the organic ligands include an acetic acid, a propionic acid, a valeric acid, a butyric acid, a carboxylic acid, a phosphoric acid, a primary amine compound, a quaternary amine compound, hydroxyoximes, organophosphorus acids, dialkylsulphoxides, diglycoamides, thiodiglycoamides, malonamides, diisopentylsulfides, pyridine-carboxamides, dialkyl/arylureas, or combinations thereof.

10. The method according to claim 1, wherein the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof.

11. The method according to claim 10, further comprising:
contacting at least a portion of the solution with scCO₂; and
precipitating a rare-earth-element (REE) product including REE-ligand complexes from the solution.

12. The method according to claim 1, wherein the waste feed stock includes fly ash, iron slag, steel slag, red mud, printed circuit board, or combinations thereof.

13. A system for recovering metals from waste materials, comprising:
a source of waste feed stock;
a source of supercritical CO₂ (scCO₂);
a source of at least one acid;
a source of one or more organic ligands;
a waste treatment reactor in communication with the source of waste feed stock, the source of scCO₂, and the source of at least one acid, the waste treatment reactor including a first outlet and a second outlet;
a liquid delaminated waste stream in communication with the first outlet, the liquid delaminated waste stream including alkaline earth metals, transition metals, rare earth elements (REEs), or combinations thereof;
a solid delaminated waste stream in communication with the second outlet;
a metal enrichment reactor in communication with solid delaminated waste stream and configured to perform a flotation separation process, gravity separation process, or combinations thereof on the solid delaminated waste stream, the metal enrichment reactor further comprising a third outlet;
an enriched-metal solid delaminated waste stream in fluid communication with the third outlet;
a leaching reactor in communication with the enriched-metal solid delaminated waste stream, liquid delaminated waste stream, or combinations thereof, and the source of one or more organic ligands, the leaching reactor including a solution including a plurality of metal-ligand complexes formed from a solvent including one or more organic ligands and at least a portion of the enriched-metal solid delaminated waste stream, liquid delaminated waste stream, or combinations thereof; and
an electrochemical separation module configured to electrochemically separate a first product from the solution, the first product including a first metal from a first-metal-ligand complex of the plurality of metal-ligand complexes.

14. The system according to claim 13, further comprising a separation reactor in fluid communication with the leaching reactor and the source of scCO₂, the separation reactor further comprising:
a rare-earth-element (REE) product stream including REE-ligand complexes from the solution.

15. The system according to claim 13, further comprising:
a carbonation reactor in fluid communication with the liquid delaminated waste stream; and
an alkaline earth metal product stream in communication with the carbonation reactor, the alkaline earth metal product stream including carbonated alkaline earth metals.

16. The system according to claim 13, wherein the waste feed stock includes fly ash, iron slag, steel slag, red mud, printed circuit board, or combinations thereof.

17. The system according to claim 13, wherein the organic ligands include an acetic acid, a propionic acid, a valeric acid, a butyric acid, a carboxylic acid, a phosphoric acid, a primary amine compound, a quaternary amine compound, hydroxyoximes, organophosphorus acids, dialkylsulphoxides, diglycoamides, thiodiglycoamides, malonamides, diisopentylsulfides, pyridine-carboxamides, dialkyl/arylureas, or combinations thereof.

18. The system according to claim 13, wherein the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof.

19. A method of recovering metals from waste materials, comprising:
treating a waste feed stock with supercritical CO₂ (scCO₂), at least one acid, and a grinding medium to produce a solid delaminated waste, a liquid delaminated waste, and a solid gold product;
separating the solid delaminated waste from the liquid delaminated waste;
isolating the solid gold product from the solid delaminated waste, the liquid delaminated waste, or combinations thereof;
carbonating alkaline earth metals from the liquid delaminated waste to form a carbonated alkaline earth metal product;
separating the solid delaminated waste into an enriched-metal solid delaminated waste and an enriched-polymer solid delaminated waste via a flotation separation process, gravity separation process, or combinations thereof;
preparing a solution including the enriched-metal solid delaminated waste, liquid delaminated waste, or combinations thereof, and a solvent including one or more organic ligands;
binding the one or more organic ligands to target metals in the solution to form a plurality of metal-ligand complexes;
contacting the solution with scCO₂; and
electrochemically separating at least a first product from the solution, including altering the pH of the solution to release metals from the metal-ligand complexes at different pHs,
wherein the organic ligands include neodecanoic acid, diethylenetriamine, diethylenetriaminepentaacetic acid, N,N-bis(phosphonomethyl)glycine, peracetic acid, Cyanex923, Cyanex 301, LIX 63, di(2-ethylhexyl)phosphoric acid (D2EHPA), tributyl phosphate, phenanthroline, TriNOx, hydroxamic acid, glutarimide-dioxime, carbamoylmethylphosphine, diglycoamide, alkylated triazinyl pyridines, Acorga M5640, or combinations thereof.

20. The system according to claim 19, wherein the waste feed stock includes fly ash, iron slag, steel slag, red mud, printed circuit board, or combinations thereof.
